(19) United States
(12) Patent Application Publication
(10) Pub. No.: US 2007/0224416 A1
(43) Pub. Date: Sep. 27, 2007

(54) Easily Applicable Pressure-Sensitive Adhesive Sheet and Process for Production Thereof

(75) Inventors: Yumiko Matsubayashi, Saitama (JP); Kiichiro Kato, Saitama (JP); Osamu Kanazawa, Saitama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: LINTEC CORPORATION, ITABASHI-KU TOKYO JAPAN (JP)

(21) Appl. No.: 11/597,659

(22) PCT Filed: May 18, 2005
(86) PCT No.: PCT/JP05/09093

§ 371 Date: Nov. 24, 2006

(30) Foreign Application Priority Data
May 25, 2004 (JP) 2004-154484

(51) Int. Cl. C09J 7/02

(52) U.S. Cl. 428/343; 427/208.4

(57) ABSTRACT

Provided is a pressure-sensitive adhesive sheet comprising a substrate sheet and provided thereon an adhesive layer, wherein taper type concave grooves which are opened to an end edge part of the pressure-sensitive adhesive sheet and which are expanded toward a surface direction of the adhesive layer are provided in the adhesive layer in the form of plural parallel straight or curved belts, a lattice or an oblique lattice, and through holes having a diameter of 0.1 to 100 μm on the surface of the substrate sheet which pass through one face of the pressure-sensitive adhesive sheet to the other face thereof are provided in the substrate sheet and the adhesive layer at a density of 10 to 10000 holes/100 cm². According to the present invention, obtained is an easily applicable pressure-sensitive adhesive sheet which is liable to allow air to escape when applied to an adherend and can readily be applied clearly with good adhesion and which can remove and prevent air bubbles and blisters even when surrounded in the whole part of an end edge part or exposed to high temperature after applied to prevent an appearance from being damaged and is useful for application particularly as a large-sized pressure-sensitive adhesive sheet.

### BACKGROUND OF THE INVENTION

The present invention relates to an easily applicable pressure-sensitive adhesive sheet and a production process for the same. More specifically, the present invention relates to an easily applicable pressure-sensitive adhesive sheet which is liable to allow air to escape when applied to an adherend and can readily be applied and which can remove and prevent air bubbles and blisters even when surrounded in the whole part of an end edge part thereof or exposed to high temperature after applied to prevent an appearance from being damaged and is useful for application particularly as a large-sized pressure-sensitive adhesive sheet such as a pressure-sensitive adhesive sheet for identification and decoration and a pressure-sensitive adhesive sheet for masking in painting and a process for efficiently producing the same.

### RELATED ART

In general, a pressure-sensitive adhesive sheet is constituted from a substrate sheet, an adhesive layer formed thereon and a release sheet provided, if necessary, thereon, and when the release sheet is provided, the above release sheet is peeled off in use to bring the adhesive layer into contact with an adherend and apply it.

However, when an area of a pressure-sensitive adhesive sheet is large to some extent as is the case with a pressure-sensitive adhesive sheet for identification and decoration, a pressure-sensitive adhesive sheet for masking in painting and a pressure-sensitive adhesive sheet for protecting the surfaces of a metal plate and the like, air bubbles are liable to be produced between the adhesive layer and the adherend, and blisters are formed on the above part to bring about the problem that it is difficult to apply clearly the pressure-sensitive adhesive sheet onto the adherend.

In order to solve such problem as described above, there have so far been made such various attempts that flow paths for air are disposed on an adhesive layer surface and that air is allowed to escape through the above flow paths in applying a pressure-sensitive adhesive sheet so that air bubbles are prevented from being produced. Proposed are, for example, a pressure-sensitive adhesive sheet having an adhesive layer in which a lot of independent small convex parts are disposed in a dispersed form (refer to, for example, a patent document 1 and a patent document 2), an easily applicable pressure-sensitive adhesive sheet having flow paths for air on an adhesive surface (refer to, for example, a patent document 3), a pressure-sensitive adhesive sheet for photochemical engraving having an adhesive layer in which groove forms capable of forming air flow paths are provided (refer to, for example, a patent document 4) and a pressure-sensitive adhesive sheet having an adhesive layer in which plural convex parts and groove parts between the adjacent convex parts are formed (refer to, for example, a patent document 5).

However, while air is liable to escape when the above pressure-sensitive adhesive sheets and pressure-sensitive adhesive tapes to make it possible to readily apply them on an adherend, involved therein are the drawbacks that adhesion with the adherend is unsatisfactory and that uneven structures and groove structures stand out on a substrate surface to damage the appearance of the pressure-sensitive adhesive sheets after applied, and therefore they have not necessarily been sufficiently satisfactory.

Also, in the above pressure-sensitive adhesive sheets and pressure-sensitive adhesive tapes, surrounding of the whole parts of the end edge parts thereof after applied on an adherend has resulted in sealing concave grooves (flow paths) which allow air and gas to pass and making it impossible to remove and prevent air bubbles.

Further, in the above pressure-sensitive adhesive sheets and pressure-sensitive adhesive tapes, when exposed to high temperature after applied to the adherend, the adhesive layer is fluidized to allow the concave grooves (flow paths) to disappear, and therefore when residual air bubble or shortage of following to the adherend is found after exposed to high temperature or when blisters are produced by gas generated from the adherend, air or gas has not been able to be discharged to the outside to make it impossible to remove and prevent air bubbles.

On the other hand, proposed as well is a stripe tape comprising a film of a synthetic resin and an adhesive, which has a lot of fine pores passing through the film and the adhesive and which does not produce air voids between the adherend and the stripe tape (refer to, for example, a patent document 6).

However, the fine pores have to be provided at a high density in order to sufficiently prevent air bubbles from being produced in the above pressure-sensitive adhesive sheet without damaging an appearance and a sheet strength, and the problem that the productivity is inferior is involved therein.
Patent document 1: Japanese Utility Model Registration No. 2503717
Patent document 2: Japanese Utility Model Registration No. 2587198
Patent document 3: Japanese Patent Application Laid-Open No. 223081/1988
Patent document 4: Japanese Patent Application Laid-Open No. 248243/1994
Patent document 5: Japanese Patent Application Laid-Open No. 209704/1999
Patent document 6: Japanese Utility Model Application Laid-Open No. 100235/1992

### DISCLOSURE OF THE INVENTION

In light of the circumstances described above, an object of the present invention is to provide an easily applicable pressure-sensitive adhesive sheet which is liable to allow air to escape when applied to an adherend and can readily be applied clearly with good adhesion and which can remove and prevent air bubbles and blisters even when surrounded in the whole part of an end edge part thereof or exposed to high temperature after applied to prevent an appearance from being damaged and is useful for application particularly as a large-sized pressure-sensitive adhesive sheet.

Intensive researches repeated by the present inventors in order to achieve the object described above have resulted in finding that the object described above can be achieved by providing concave grooves opened to an end edge part of a pressure-sensitive adhesive sheet on an adhesive layer and disposing holes having a specific diameter which pass through one face of the pressure-sensitive adhesive sheet to the other face thereof at a specific density in a substrate sheet and the adhesive layer. The present invention has been completed based on the above knowledge.

That is, the present invention provides:
(1) an easily applicable pressure-sensitive adhesive sheet comprising a substrate sheet and provided thereon an adhesive layer, wherein taper type concave grooves which are opened to an end edge part of the pressure-sensitive adhesive sheet and which are expanded toward a surface direction of the adhesive layer are provided in the adhesive layer in the form of plural parallel straight or curved belts, a lattice or an oblique lattice, and through holes having a diameter of 0.1 to 100 μm on the surface of the substrate sheet which pass through one face of the pressure-sensitive adhesive sheet to the other face thereof are provided in the substrate sheet and the adhesive layer at a density of 10 to 10000 holes/100 cm²,
(2) the easily applicable pressure-sensitive adhesive sheet as described in the above item (1), wherein in the adhesive layer, an area of a flat part is 50 to 90%; a cutting edge angle of the concave groove to a flat surface is 20 to 75°; a width of an upper face aperture part in the concave groove is 10 to 80 μm; and a depth of the concave groove is 5 to 50 μm,
(3) the easily applicable pressure-sensitive adhesive sheet as described in the above item (1) or (2), wherein the group of the concave grooves in the same direction in the end edge part of the pressure-sensitive adhesive sheet has a pitch of 50 to 400 μm,
(4) the easily applicable pressure-sensitive adhesive sheet as described in any of the above items (1) to (3), wherein the through holes are provided by arranging them regularly in the concave grooves of the adhesive layer,
(5) the easily applicable pressure-sensitive adhesive sheet as described in any of the above items (1) to (3), wherein the through-holes are provided by arranging them regularly in the flat part of the adhesive layer,
(6) the easily applicable pressure-sensitive adhesive sheet as described in any of the above items (1) to (5), wherein a diameter of the through hole gradually decreases from an adhesive layer side of the pressure-sensitive adhesive sheet toward a substrate sheet side thereof,
(7) the easily applicable pressure-sensitive adhesive sheet as described in any of the above items (1) to (6), wherein a diameter of the through hole on the surface of the substrate sheet is 0.1 to 50 μm, and a density thereof is 10 to 5000 holes/100 cm²,
(8) the easily applicable pressure-sensitive adhesive sheet as described in any of the above items (1) to (7), wherein a thickness of the adhesive layer is 15 to 100 μm,
(9) a production process for the easily applicable pressure-sensitive adhesive sheet as described in any of the above items (1) to (8), comprising:

forming an adhesive layer on a releasably treated layer of a release sheet on which the above releasably treated layer having a shape transfer face on a surface is provided and then

irradiating a laminated sheet in which a substrate sheet, the adhesive layer and the release sheet are laminated in order, obtained by applying the substrate sheet on the above adhesive layer, with a laser beam to provide through holes,
(10) the production process for the easily applicable pressure-sensitive adhesive sheet as described in the above item (9), wherein the laser beam is irradiated from a release sheet side of the laminated sheet in which the substrate sheet, the adhesive layer and the release sheet are laminated in order,
(11) the production process for the easily applicable pressure-sensitive adhesive sheet as described in the above item (9), wherein a casting sheet or a protective adhesive sheet is further laminated on the surface of the substrate sheet of the laminated sheet in which the substrate sheet, the adhesive layer and the release sheet are laminated in order, and then the laser beam is irradiated thereon.

### BRIEF DESCRIPTIONS OF THE DRAWINGS

FIG. 1 is an explanatory drawing of a planar structure of an adhesive layer in one example of the pressure-sensitive adhesive sheet of the present invention.

FIG. 2 is cross-sectional shape drawings of different taper type concave grooves provided on an adhesive layer in the pressure-sensitive adhesive sheet of the present invention.

FIG. 3 is an explanatory drawing of shape characteristic values in a taper type concave groove provided on an adhesive layer in the pressure-sensitive adhesive sheet of the present invention.

FIG. 4 is an explanatory drawing of a cross-sectional structure of a through hole in one example of the pressure-sensitive adhesive sheet of the present invention.

FIG. 5 is a cross-sectional drawing of one example of the pressure-sensitive adhesive sheet of the present invention.

### EXPLANATION OF THE CODES

1: Substrate sheet
2: Adhesive layer
3: Taper type concave groove
3A: Taper type concave groove group
3B: Taper type concave groove group
4: Release sheet
5: Through hole
10: Pressure-sensitive adhesive sheet

### BEST MODE FOR CARRYING OUT THE INVENTION

In the easily applicable pressure-sensitive adhesive sheet of the present invention (hereinafter referred to as the pressure-sensitive adhesive sheet of the present invention), the substrate sheet shall not specifically be restricted, and optional ones suitably selected from those conventionally used as a substrate sheet for a pressure-sensitive adhesive sheet can be used.

The above substrate sheet includes, for example, papers such as woodfree paper, glassine paper and coated paper, plastic sheets of polyesters (for example, polyethylene terephthalate and polyethylene naphthalate), polyolefins (for example, polypropylene and polyethylene), polyvinyl chloride, polyvinylidene chloride, polystyrene, polycarbonate, polyvinyl alcohol, polyurethane and acrylic base resins and cellulose base sheets of cellulose triacetate, cellulose diacetate and cellophane.

A thickness of the above substrate sheet may suitably be determined according to the use purposes and the situation, and it falls in a range of usually 10 to 300 μm, preferably 50 to 150 μm.

When a plastic sheet is used as the above substrate sheet, it can be subjected, if necessary, to roughening treatment by sand blast and solvent treatment and oxidizing treatment such as corona discharge treatment, ozone•UV ray irradiation treatment, flame treatment, chromic acid treatment and hot air treatment for the purpose of enhancing adhesion with an adhesive layer provided thereon.

An adhesive used for forming the adhesive layer provided on the surface of the substrate sheet shall not specifically be restricted, and capable of being used are those which have so far conventionally been used for an adhesive layer of a pressure-sensitive adhesive sheet, for example, acrylic base adhesives, polyurethane base adhesives, polyester base adhesives, rubber base adhesives and silicone base adhesives.

The adhesive may be any of an emulsion type, a solvent type and a non-solvent type and may be any of a cross-linked type and a non-cross-linked type.

In the pressure-sensitive adhesive sheet of the present invention, concave grooves of a taper type expanded toward a surface direction of the adhesive layer which are opened to an end edge part of the pressure-sensitive adhesive sheet are provided on the adhesive layer in the form of plural parallel straight or curved belts, a lattice or an oblique lattice.

A state in which the concave grooves of a taper type is provided shall be explained below with a case in which they are provided in the form of an oblique lattice being cited as an example.

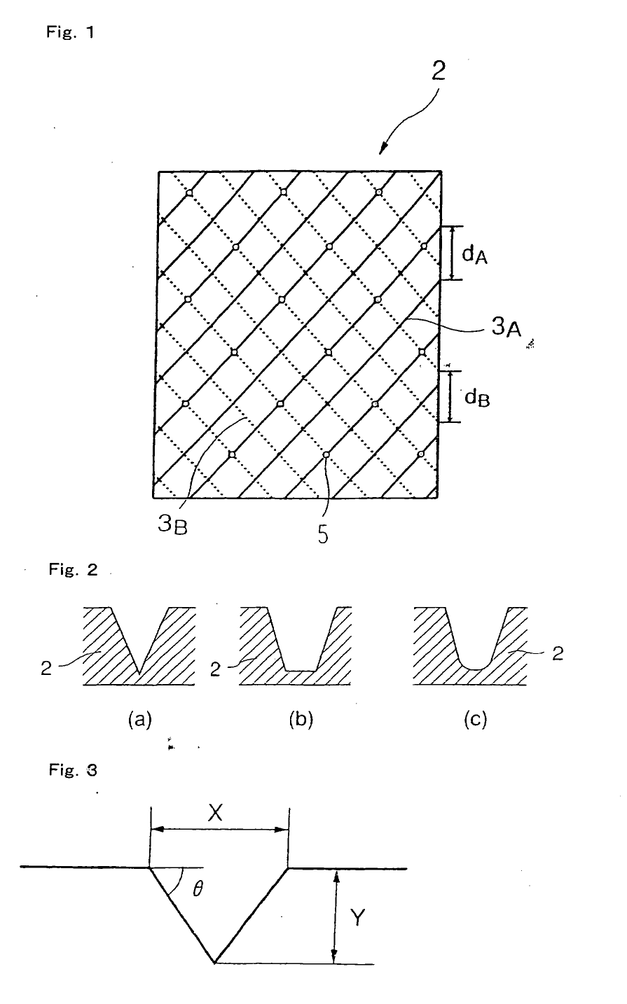

FIG. 1 is an explanatory drawing of a planar structure of an adhesive layer in one example of the pressure-sensitive adhesive sheet of the present invention.

The adhesive layer 2 has, when viewing FIG. 1 from a front side, a structure in which a concave groove group 3A (solid line part) comprising plural parallel tapered concave grooves going up toward a right direction intersects with a concave groove group 3B (broken line part) comprising plural parallel tapered concave grooves going up toward a left direction to form an oblique lattice.

In the pressure-sensitive adhesive sheet of the present invention, the concave grooves may be, as shown in FIG. 1, a plural parallel straight or curved belts form or a lattice form as well as an oblique lattice form.

The shape of the concave grooves shall not specifically be restricted as long as they have a taper type expanded toward a surface direction of the adhesive layer, and various shapes, for example, those having cross-sectional shapes shown in FIG. 2 can be given. In FIG. 2, (a) shows a V groove; (b) shows a reverse trapezoidal groove; and (c) shows a taper type U groove. The code 2 is an adhesive layer.

The respective taper type grooves are opened to the end edge part of the pressure-sensitive adhesive sheet to constitute flow paths for air, and air is discharged through the above flow paths in applying. Accordingly, air bubbles are not produced, and the pressure-sensitive adhesive sheet can clearly be applied on an adherend with closed contact.

The pitches of the concave groove groups in the same direction at the end edge part of the pressure-sensitive adhesive sheet, that is, a pitch dA of the concave groove group 3A and a pitch dB of the concave groove group 3B in FIG. 1 shall not specifically be restricted as long as they have such values that the flat parts in the adhesive layer each have areas falling in a range of 50 to 90% described later. They are selected in a range of usually 50 to 400 μm, preferably 100 to 300 μm. In a case where they are provided in the form of a lattice or an oblique lattice, the pitches dA and dB described above may be the same value or different values. Further, the pitches dA of the respective concave grooves in the concave groove group A may be the same or different, and the pitches dB of the respective concave grooves in the concave groove group B may be the same or different.

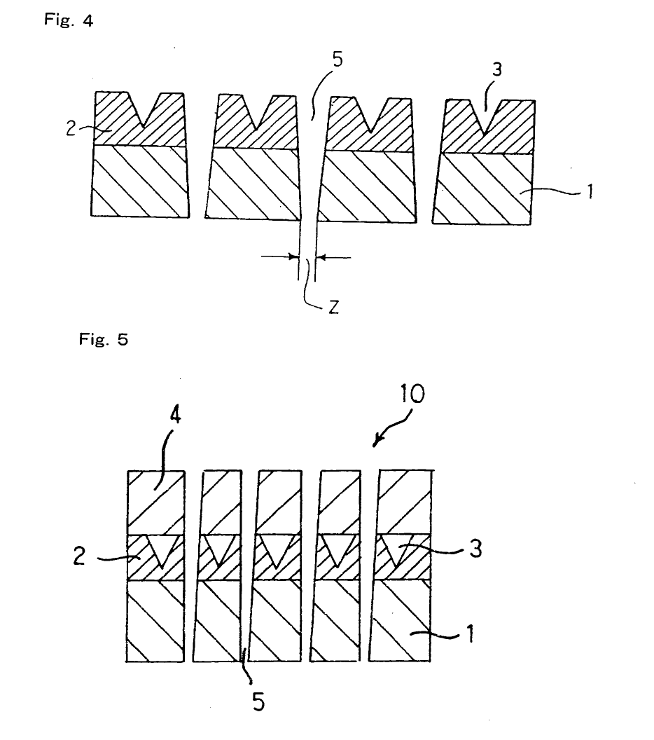

FIG. 3 is an explanatory drawing of shape characteristic values in a taper type concave groove. In FIG. 3, θ shows a cutting edge angle; X shows a width of an aperture part on an upper face; and Y shows a depth.

In the pressure-sensitive adhesive sheet of the present invention, the cutting edge angle θ is preferably 20 to 75°; the width X of the aperture part on the upper face is preferably 10 to 80 μm; and the depth is preferably 5 to 50 μm.

If the cutting edge angle is less than 20°, it is difficult to allow air to escape when applying the pressure-sensitive adhesive sheet to the adherend to produce air bubbles, and it is likely that the object of the present invention is not achieved. On the other hand, if the cutting edge angle exceeds 75°, an air layer is produced between the adhesive layer and the base material of the release sheet when the above adhesive layer is formed on a shape transfer face of the release sheet, and the problem that transfer can not be carried out well is likely to be brought about. Because of the above reasons, the particularly preferred cutting edge angle falls in a range of 30 to 60°.

Also, if the width of the aperture part on the upper face is less than 10 μm or the depth is less than 5 μm, it is difficult to allow air to escape when applying the pressure-sensitive adhesive sheet to the adherend to produce air bubbles, and it is likely that the object of the present invention is not achieved. On the other hand, if the width of the aperture part on the upper face exceeds 80 μm or the depth exceeds 50 μm, a contact area of the adhesive layer with the adherend is decreased, and the adhesive strength is unsatisfactory. In addition thereto, dents are produced on the surface of the substrate sheet after applying the pressure-sensitive adhesive sheet to the adherend, and they are likely to cause damage of the appearance.

The particularly preferred width of the aperture part on the upper face falls in a range of 30 to 70 μm, and the particularly preferred depth falls in a range of 10 to 40 μm.

Further, an area of the flat part falls preferably in a range of 50 to 90%. If the above area of the flat part is less than 50%, an adhesive strength between the pressure-sensitive adhesive sheet and the adherend is likely to be unsatisfactory. On the other hand, if it exceeds 90%, it is difficult to allow air to escape when applying the pressure-sensitive adhesive sheet to the adherend to produce air bubbles, and it is likely that the object of the present invention is not achieved. The particularly preferred area of the flat part falls in a range of 60 to 90%.

The area of the flat part referred to in the above case means an area in a case of assuming that when through holes are provided in the flat part as described later, the above through holes are not present, in other words, an area including an aperture area of the above through holes.

A thickness of the adhesive layer is selected in a range of usually 15 to 100 μm, preferably 20 to 50 μm. In the above adhesive layer, the substrate sheet may be brought into contact with the bottom part of the taper type concave groove or may be separated from it.

In the pressure-sensitive adhesive sheet of the present invention, the concave grooves described above are provided in the adhesive layer, and provided are the through holes passing through one surface of the pressure-sensitive adhesive sheet comprising the substrate sheet and the adhesive layer to the other face thereof.

FIG. 4 is an explanatory drawing of a cross-sectional shape in one example of the pressure-sensitive adhesive sheet of the present invention, and provided is a through hole passing through the surface of a side (hereinafter referred to as ┌front side┘) of a substrate sheet 1 which is not brought into contact with an adhesive layer 2 to the surface of a side (hereinafter referred to as ┌back side┘) of the adhesive layer 2 having a concave groove 3 which is not brought into contact with the substrate sheet 1.

The direction of the through hole is almost perpendicular to the surface of the pressure-sensitive adhesive sheet.

A diameter (represented by Z in FIG. 4) of the through hole on the surface of the substrate sheet has to be 0.1 to 100 μm, and it is preferably 0.1 to 50 μm, particularly preferably 0.1 to 40 μm. If the above diameter on the surface of the substrate sheet is less than 0.1 μm, the object of allowing air to escape can not sufficiently be achieved. On the other hand, if it exceeds 100 μm, the presence of the hole is conspicuous and results in damaging the commercial value because of the inferior appearance.

The shape of the through hole does not have to be a cylindrical form in which a diameter is the same from the front side to the back side as long as the diameter on the surface of the substrate sheet falls in the range described above, and it may be a taper type in which a diameter is gradually decreased from the back side to the front side or a reverse taper type in which a diameter is gradually decreased from the front side to the back side or may be a form in which they are present in a mixture.

However, the taper type in which a diameter is gradually decreased, as shown in FIG. 4, from the back side to the front side is preferred in the sense of achieving both objects of allowing air to smoothly escape and making the presence of the hole inconspicuous.

The hole assuming “a cylindrical form” or “a taper form” does not necessarily have to be exactly cylindrical or right circular conic trapezoidal, and it may be a form having a little bulge in the middle.

The through holes have to be provided at a density of 10 to 10000 holes/100 cm², preferably 10 to 5000 holes/100 cm² and particularly preferably 10 to 3000 holes/100 cm². If the above density is less than 10 holes/100 cm², the object of allowing air to escape can not sufficiently be achieved. On the other hand, if it exceeds 10000 holes/100 cm², caused are the problems that a reduction in the adhesive strength is brought about and that a mechanical strength of the pressure-sensitive adhesive sheet is reduced.

The through holes do not have to be regularly provided and may be irregularly provided, and they may be provided only in one of the concave groove and the flat part in the adhesive layer or both of them. When the through holes are provided only in one of the concave groove and the flat part, a shift of structure in a thickness direction of the pressure-sensitive adhesive sheet is not present, and therefore the diameter is readily controlled. Considering a flow path for air, the through holes are particularly preferably provided regularly in the concave groove of the adhesive layer.

FIG. 1 shows a case in which the through hole 5 is provided regularly in an intersecting part of the concave groove 3.

Various processes can be employed as the production process for the pressure-sensitive adhesive sheet of the present invention. First, an adhesive layer in which taper type concave grooves are provided in a prescribed shape is formed on the surface of a substrate sheet to prepare a laminated sheet, and then this laminated sheet is suitably drilled to provide through holes.

Capable of being employed as a method for forming the adhesive layer in which the taper type concave grooves are provided in a prescribed shape on the surface of the substrate sheet are, for example, (1) a method in which a comb-shaped blade is used to form the adhesive layer having the shape described above directly on the surface of the substrate sheet, (2) a method in which a flat adhesive layer is formed directly on the surface of the substrate sheet and in which the above adhesive layer is then brought into contact with an embossing roll to form the adhesive layer in which the taper type concave grooves are provided in a prescribed shape and (3) a method in which a shape formed on a releasably treated face of the release sheet is transferred on the adhesive layer and in which the substrate sheet is applied on the above adhesive layer. Among them, the transferring method of (3) is suited from the viewpoint of the handling property.

In the above transferring method of (3), the adhesive layer is formed on the releasably treated layer of the release sheet on which the above releasably treated layer having a shape transferring face on a surface is provided, and then the substrate sheet is applied on the above adhesive layer, whereby capable of being produced is a laminated sheet in which the adhesive layer provided thereon with concave grooves of a prescribed shape is formed on the surface of the substrate sheet and in which the release sheet is laminated on the above adhesive layer.

In the above case, the release sheet on which the above releasably treated layer having a shape transferring face on a surface is provided can be produced, for example, by applying a releasing agent such as a silicone on a substrate for a release sheet to provide a releasably treated layer and subjecting it to shape processing by a publicly known method. The adhesive layer in which the taper type concave grooves are provided in a prescribed shape can be formed by transferring the above releasably treated layer. The substrate for the release sheet used in this case shall not specifically be restricted, and optional ones selected from those which have so far conventionally been used as a substrate for a release sheet can be used. The above substrate for the release sheet includes, for example, papers such as glassine paper, coated paper and laminated paper and various plastic films.

The laminated sheet obtained by the method described above comprising the substrate sheet and the adhesive layer in which the taper type concave grooves are provided in a prescribed shape is drilled to provide holes passing through the surface of the front side to the surface of the back side. Various methods can be employed as a drilling method for the same, and a method for irradiating with a laser beam is preferred from the viewpoints that through holes having an optional diameter which is relatively small can be provided and that the tape can be prevented from being stained because of non-contact.

YAG, UV-YAG, eximer, CO₂, TEA-CO₂, semiconductors, YVO₄, YLF, femtosecond and the like can be used as the kind of the laser beam, and CO₂ is preferably used in terms of the production efficiency and the cost. A diameter of the through hole can be controlled by controlling a focal point of the laser beam by means of a condenser lens provided in an irradiating apparatus.

A direction of irradiating with the laser beam may be either of the back side (adhesive layer side) and the front side (substrate sheet side). Usually, a hole drilled with a laser beam assumes a form in which a diameter is gradually decreased as apart from a side irradiated, and therefore it may suitably be selected by selecting any of a form in which the diameter is gradually decreased from the back side to the front side, a form in which the diameter is gradually decreased, contrary to the above, from the front side to the back side and a form in which they are present in a mixture.

As described above, the form in which the diameter is gradually decreased from the back side to the front side is preferred, and therefore the laser beam is irradiated preferably from the back side (adhesive layer side).

When drilled by irradiating with the laser beam, a thermally molten matter called a dross is formed at an edge in a substrate sheet side of the through hole in irradiating from either side, and the appearance is damaged in a certain case.

However, irradiating with the laser beam in a state in which a casting sheet or a protective adhesive sheet is laminated on the surface of the substrate sheet allows the thermally molten matter to be formed on the casting sheet or the protective adhesive sheet to make it possible to prevent the thermally molten matter from being formed at the edge in the substrate sheet side of the through hole, and the appearance on the surface of the substrate sheet after removing the above casting sheet or protective adhesive sheet can be maintained in a good state.

The above casting sheet or protective adhesive sheet may be laminated on the surface of the substrate sheet in drilling, but when produced by a method such as cast film forming in which the casting sheet is used on the substrate sheet, a process leading to drilling is carried out as the casting sheet is allowed to remain, and a laser beam is irradiated as the casting sheet is allowed to remain, whereby the effect described above can be obtained. Accordingly, it is convenient.

When the transferring method of (3) described above is employed, obtained is the laminated sheet in which the adhesive layer provided thereon with the concave grooves of a prescribed shape is formed on the surface of the substrate sheet and in which the release sheet is laminated on the above adhesive layer. In this case, holes passing through the whole part of the laminated sheet including the release sheet are preferably provided from the viewpoint of the workability.

Accordingly, if irradiating with the laser beam in a state in which the casting sheet or the protective adhesive sheet is laminated on the surface of the substrate sheet, preferably provided are holes passing through all of the release sheet, the adhesive layer, the substrate sheet and the casting sheet or the protective adhesive sheet.

FIG. 5 is an explanatory drawing of a cross-sectional structure in one example of the pressure-sensitive adhesive sheet of the present invention obtained by drilling a laminated sheet in which an adhesive layer and a release sheet are laminated in order on the surface of a substrate sheet, and the pressure-sensitive adhesive sheet 10 has a structure in which the adhesive layer 2 having taper type concave grooves 3 and the release sheet 4 are laminated in order on the surface of the substrate sheet 1 and in which through holes 5 passing through them are provided.

In using the pressure-sensitive adhesive sheet of the present invention, the release sheet is peeled off when it is present, and then the adhesive layer is brought into contact with an adherend and applied thereon while exerting pressure by means of a squeegee or a finger, whereby air is allowed to escape with the taper type concave grooves and the through holes functioning as flow paths for air to prevent air bubbles from being produced. Accordingly the adhesive sheet can readily be applied clearly with good adhesion. Further, the appearance of the pressure-sensitive adhesive sheet after applied is not damaged by dents produced on the surface of the substrate sheet and groove structures embossed.

### EXAMPLES

Next, the present invention shall be explained in further details with reference to examples, but the present invention shall by no means be restricted by these examples.

### Examples 1 to 6

Polyethylene was laminated on a woodfree paper of 110 g/m² in a thickness of 30 μm, and then a silicone is coated on the surface of polyethylene, whereby a releasably treated layer having a thickness of 0.5 μm was formed to prepare a release sheet. A shape transferring face was formed on a releasably treated layer side of the above release sheet by embossing. Next, an adhesive layer having a thickness of 30 μm was formed on the releasably treated layer of the above release sheet by coating an acrylic base adhesive (trade name: PK, manufactured by Lintec Corporation), and then a black opaque vinyl chloride substrate sheet having a thickness of 100 μm (trade name: KBOG20103100, manufactured by Kyowa Leather Cloth Co., Ltd.) was applied on the above adhesive layer.

This provided a release sheet-disposed laminated sheet having the adhesive layer in which tapered concave grooves shown in Table 1 and Table 2 were provided in an oblique lattice form.

In the case of Example 6, a casting sheet used in the production was laminated on the black opaque vinyl chloride substrate sheet used as the substrate sheet, and therefore obtained was the release sheet-disposed laminated sheet in which the release sheet, the adhesive layer, the substrate sheet and the casting sheet were laminated in order.

Then, the above release sheet-disposed laminated sheet was irradiated with a laser beam (light source: CO₂) to provide through holes. The irradiating conditions of the laser beam and the shapes of the through holes are shown in Table 1 and Table 2. The diameters of the through holes were measured by means of a scanning type electronic microscope (S-2360N type, manufactured by Hitachi, Ltd.). In the case of Example 6, the laser beam (light source: CO₂) was irradiated from a casting sheet side of the release sheet-disposed laminated sheets having the constitution described above.

The release sheet-disposed pressure-sensitive adhesive sheets thus obtained were subjected to an air bubble disappearing test and appearance observation by the following methods, and the results thereof are shown in Table 1 and Table 2.

Air Bubble Disappearing Test:

The test was carried out by the following method A, method B and method C, and the results were judged according to the following criteria:
◯: air bubbles were removed immediately after pressed
X: air bubbles were reduced in size by pressing but not completely removed
   Method A:

A release sheet was peeled off from a release sheet-disposed pressure-sensitive adhesive sheet of 50×50 mm, and an adhesive face of the adhesive sheet was pressed onto a melamine-coated plate of 70×70 mm so that circular air bubble having a diameter of 15 mm was produced to visually observe if the air bubble was removed.

Method B:

A release sheet was peeled off from a release sheet-disposed pressure-sensitive adhesive sheet of 100×100 mm, and an adhesive face of the adhesive sheet was pressed onto a melamine-coated plate of 70×70 mm with all four sides of the adhesive sheet being protruded from the melamine-coated plate so that circular air bubble having a diameter of 15 mm was produced. It was applied so that the adhesive sheet protruded wound around the coated plate. In this case, the corners of the coated plate were strongly pressed. Then, it was visually observed if the air bubble was removed.

Method C:

A release sheet was peeled off from a release sheet-disposed pressure-sensitive adhesive sheet of 50×50 mm, and an adhesive face of the adhesive sheet was pressed onto a melamine-coated plate of 70×70 mm so that circular air bubble having a diameter of 15 mm was produced. Then, the coated plate was put in a constant temperature bath of 80° C. and taken out after 24 hours passed, and it was left standing at room temperature for one hour to visually observe if the air bubble was removed.

Appearance of the surface of the substrate sheet

Visually observed and evaluated according to the following criteria:
1: through holes are not visible, and appearance is very good
2: through holes are found to be present in a certain case depending on the conditions, but appearance is very good
3: through holes are scarcely visible, and appearance is good
4: through holes are visible, and appearance is damaged

### Comparative Example 1

A release sheet-disposed pressure-sensitive adhesive sheet was prepared in the same manner as in Example 1 and evaluated in the same manner, except that an adhesive layer having no taper type concave grooves was formed by using a release sheet having no emboss and that through holes were not provided in the release sheet-disposed laminated sheet. The results thereof are show in Table 2.

### Comparative Example 2

A release sheet-disposed pressure-sensitive adhesive sheet was prepared in the same manner as in Example 1 and evaluated in the same manner, except that through holes were not provided in the release sheet-disposed laminated sheet. The results thereof are show in Table 2.

### Comparative Example 3

A release sheet-disposed pressure-sensitive adhesive sheet was prepared in the same manner as in Example 1 and evaluated in the same manner, except that through holes described in Table 2 were provided. The results thereof are show in Table 2.

TABLE 1

| | | | Example | | | | |
|---|---|---|---|---|---|---|---|
| | | | 1 | 2 | 3 | 4 | 5 |
| Concave | Flat part area | % | 68 | 68 | 68 | 68 | 68 |
| groove | Cutting edge | · | 45 | 45 | 45 | 45 | 45 |
| | angle; θ | | | | | | |
| | Concave groove | μm | 35 | 35 | 35 | 35 | 35 |
| | aperture width; X | | | | | | |
| | Concave groove | μm | 17 | 17 | 17 | 17 | 17 |
| | depth; Y | | | | | | |
| | Concave groove | μm | 200 | 200 | 200 | 200 | 200 |
| | pitch | | | | | | |

| Through | Laser beam irradiating | | Back | Back | Back | Back | Front |
|---|---|---|---|---|---|---|---|
| hole | direction | | side^{a)} | side^{a)} | side^{a)} | side^{a)} | side^{b)} |
| | Diameter | μm | 10 to 40 | 10 to 40 | 35 | 35 | 45 |
| | Density | holes/100 m² | 64 | 1600 | 2500 | 2500 | 1600 |
| | of hole | | | | | | |

| | | | | | | |
|---|---|---|---|---|---|---|
| | Regularity of hole | None | None | Present/ | Present/ | None |
| | | | | concave groove | flat | |
| Air bubble | Method A | ◯ | ◯ | ◯ | ◯ | ◯ |
| disappearing | Method B | ◯ | ◯ | ◯ | ◯ | ◯ |
| test | Method C | ◯ | ◯ | ◯ | ◯ | ◯ |

| | | | | | |
|---|---|---|---|---|---|
| Appearance of substrate sheet | 1 | 1 | 1 | 1 | 3 |
| surface | | | | | |

Present/concave groove: regularly drilled in the concave grooves
Present/flat: regularly drilled in the flat part
Back side^{a)}: irradiated on the release sheet face
Front side^{b)}: irradiated on the substrate sheet face

TABLE 2

| | | | | Comparative Example | | |
|---|---|---|---|---|---|---|
| | | | Example 6 | 1 | 2 | 3 |
| Concave | Flat part area | % | 68 | None | 68 | 68 |
| groove | Cutting edge | · | 45 | | 45 | 45 |
| | angle; θ | | | | | |
| | Concave groove | μm | 35 | | 35 | 35 |
| | aperture width; X | | | | | |
| | Concave groove | μm | 17 | | 17 | 17 |
| | depth; Y | | | | | |
| | Concave groove | μm | 200 | | 200 | 200 |
| | pitch | | | | | |

| Through | Laser beam irradiating | | Front | None | None | Back |
|---|---|---|---|---|---|---|
| hole | direction | | side^{c)} | | | side^{a)} |
| | Diameter | μm | 45 | | | 180 to |
| | | | | | | 210 |
| | Density | holes/ | 1600 | | | 2500 |
| | of hole | 100 m² | | | | |

| | | | | | |
|---|---|---|---|---|---|
| | Regularity of hole | None | | | None |
| Air bubble | Method A | ◯ | X | ◯ | ◯ |
| disappearing | Method B | ◯ | X | X | ◯ |
| test | Method C | ◯ | X | X | ◯ |

| | | | | |
|---|---|---|---|---|
| Appearance of substrate sheet surface | 2 | 1 | 1 | 4 |

Front side^{c)}: irradiated on the casting sheet face
Back side^{a)}: irradiated on the release sheet face

### INDUSTRIAL APPLICABILITY

According to the present invention, obtained are an easily applicable pressure-sensitive adhesive sheet which is liable, though a diameter of a through hole and a density thereof are relatively small, to allow air to escape when applied to an adherend by combining taper type concave grooves with through holes and can readily be applied clearly with good adhesion and which can remove and prevent air bubbles and blisters even when surrounded in the whole part of an end edge part after applied or exposed to high temperature and prevents an appearance from being damaged since a diameter of the through hole and a density thereof can be made relatively small and a process for producing the same.

The pressure-sensitive adhesive sheet of the present invention is suited particularly as a large-sized pressure-sensitive adhesive sheet such as a pressure-sensitive adhesive sheet for identification and decoration, a pressure-sensitive adhesive sheet for masking in painting and a pressure-sensitive adhesive sheet for protecting the surfaces of a metal plate and the like.

What is claimed is:

1. An easily applicable pressure-sensitive adhesive sheet comprising a substrate sheet and provided thereon an adhesive layer, wherein taper type concave grooves which are opened to an end edge part of the pressure-sensitive adhesive sheet and which are expanded toward a surface direction of the adhesive layer are provided in the adhesive layer in the form of plural parallel straight or curved belts, a lattice or an oblique lattice, and through holes having a diameter of 0.1 to 100 μm on the surface of the substrate sheet which pass through one face of the pressure-sensitive adhesive sheet to the other face thereof are provided in the substrate sheet and the adhesive layer at a density of 10 to 10000 holes/100 cm².

2. The easily applicable pressure-sensitive adhesive sheet as described in claim 1, wherein in the adhesive layer, an area of a flat part is 50 to 90%; a cutting edge angle of the concave groove to a flat surface is 20 to 75°; a width of an upper face aperture part in the concave groove is 10 to 80 μm; and a depth of the concave groove is 5 to 50 μm.

3. The easily applicable pressure-sensitive adhesive sheet as described in claim 1 or 2, wherein the group of the concave groove in the same direction in the end edge part of the pressure-sensitive adhesive sheet has a pitch of 50 to 400 μm.

4. The easily applicable pressure-sensitive adhesive sheet as described in any of claims 1 to 3, wherein the through holes are provided by arranging them regularly in the concave grooves of the adhesive layer.

5. The easily applicable pressure-sensitive adhesive sheet as described in any of claims 1 to 3, wherein the through holes are provided by arranging them regularly in the flat part of the adhesive layer.

6. The easily applicable pressure-sensitive adhesive sheet as described in any of claims 1 to 5, wherein a diameter of the through hole gradually decreases from an adhesive layer side of the pressure-sensitive adhesive sheet toward a substrate sheet side thereof.

7. The easily applicable pressure-sensitive adhesive sheet as described in any of claims 1 to 6, wherein a diameter of the through hole on the surface of the substrate sheet is 0.1 to 50 μm, and a density thereof is 10 to 5000 holes/100 cm².

8. The easily applicable pressure-sensitive adhesive sheet as described in any of claims 1 to 7, wherein a thickness of the adhesive layer is 15 to 100 μm.

9. A production process for the easily applicable pressure-sensitive adhesive sheet as described in any of claims 1 to 8, comprising:
forming an adhesive layer on a releasably treated layer of a release sheet on which the above releasably treated layer having a shape transfer face on a surface is provided and then
irradiating a laminated sheet in which a substrate sheet, the adhesive layer and the release sheet are laminated in order, obtained by applying the substrate sheet on the above adhesive layer, with a laser beam to provide through holes.

10. The production process for the easily applicable pressure-sensitive adhesive sheet as described in claim 9, wherein the laser beam is irradiated from a release sheet side of the laminated sheet in which the substrate sheet, the adhesive layer and the release sheet are laminated in order.

11. The production process for the easily applicable pressure-sensitive adhesive sheet as described in claim 9, wherein a casting sheet or a protective adhesive sheet is further laminated on the surface of the substrate sheet of the laminated sheet in which the substrate sheet, the adhesive layer and the release sheet are laminated in order, and then the laser beam is irradiated thereon.
